(19) United States
(12) Patent Application Publication
(10) Pub. No.: US 2025/0236269 A1
(43) Pub. Date: Jul. 24, 2025

(54) REPAIR APPARATUS AND METHOD

(71) Applicant: JAGUAR LAND ROVER LIMITED, Whitley, Coventry, Warwickshire (GB)

(72) Inventor: Mark ROWLEY, Coventry, Warwickshire (GB)

(21) Appl. No.: 18/700,690

(22) PCT Filed: Oct. 21, 2022
(86) PCT No.: PCT/EP2022/079396

§ 371 Date: Apr. 11, 2024

(30) Foreign Application Priority Data
Oct. 22, 2021 (GB) 2115223.6

(51) Int. Cl. B60S 5/00; B21D 3/14; B62D 21/02; B62D 27/02

(52) U.S. Cl. CPC B60S 5/00; B21D 3/14; B62D 21/02; B62D 27/026

(57) ABSTRACT

Aspects of the present invention relate to a repair insert (1-n) for repairing a box member (3). The box member (3) has a plurality of walls (11-1, 11-2, 13, 15) which form one or more cell (11-n). The repair insert (1-n) includes a first clamping member (21-1) for clamping against an interior of one of the walls (11-1, 11-2, 13, 15) of the box member (3); and a first engaging member (23-1) for engaging a first one of the walls (11-1, 11-2, 13, 15) of the box member (3). A first tensioning arm (27-1) is connected to the first clamping member (21-1). At least one first reactor arm (29-n, 31-n) is coupled to the first tensioning arm (27-1). The at least one first reactor arm (29-n, 31-n) is operative to apply a biasing force for biasing the first engaging member (23-1) towards the first wall (11-1, 11-2) when the first clamping member (21-1) is clamped to the box member (3). Aspects of the present invention also relate a vehicle (5) including a repair insert (1-n); and a method of repairing a box member (3).

### TECHNICAL FIELD

The present disclosure relates to a repair apparatus and method. Aspects of the invention relate to a repair insert for a box member, a vehicle comprising a repair insert and a method of repairing a box member.

### BACKGROUND

A vehicle, such as automobile, may include longitudinal members for supporting a front body structure. First and second longitudinal members may be provided on respective sides of the vehicle. In the event of a frontal collision, one or more of the longitudinal members may be damaged. A complete replacement of the longitudinal member(s) is a complex repair. A repair of the longitudinal member may be difficult since the longitudinal member typically has a replacement box member which limits access. A localised repair may be performed by fastening a replacement section to an undamaged portion of the longitudinal member. However, this may require installation of a sleeve or fusion welding. It is known to provide an insert inside to strengthen the joint between the original longitudinal member and the replacement section. A structural adhesive may be applied to an exterior of the insert to complement the strength of the parent metal. However, the structural adhesive may be wiped off whilst inserting the insert into the longitudinal member.

It is an aim of the present invention to address one or more of the disadvantages associated with the prior art.

### SUMMARY OF THE INVENTION

Aspects and embodiments of the invention provide a repair insert for a box member, a vehicle comprising a repair insert and a method of repairing a box member as claimed in the appended claims.

According to an aspect of the present invention there is provided a repair insert for repairing a box member having a plurality of walls; the repair insert comprising:
a first clamping member for clamping against an interior of one of the walls of the box member;
a first engaging member for engaging a first one of the walls of the box member;
a first tensioning arm connected to the first clamping member; and
at least one first reactor arm coupled to the first tensioning arm;
wherein the at least one first reactor arm is operative to apply a biasing force for biasing the first engaging member towards the first wall when the first clamping member is clamped to the wall of the box member.

The repair insert is configured to repair a box member having a replacement box member. The box member typically has a closed section which limits access, thereby rendering repairs more difficult. The box member may be in form of a tube having a rectangular or square section. The repair insert can be inserted into an open end of the box member. At least in certain embodiments, the repair insert is expandable once inserted into the box member. The expansion of the repair insert may positively locate the repair insert in the box member. The repair insert may be introduced into the box member in an unexpanded (contracted) state. At least in certain embodiments, this may facilitate insertion of the repair insert without removing an adhesive. The ability to expand the repair insert may also for variations in the dimensions of the box member due to production tolerances of section profiles.

In use, the first clamping member is clamped to the wall of the box member and this causes the at least one first reactor arm to apply a biasing force to the first engaging member. The application of the biasing force may bias the first engaging member towards the first wall. At least in certain embodiments, this displacement helps to ensure more uniform contact between the repair insert and the box member. This may help positively to locate the repair insert in the box member. The repair insert may be used in conjunction with an adhesive, for example a structural adhesive. Improved contact between the first engaging member and the first wall may improve adhesion, thereby improving the structural integrity of the repair.

The box member may comprise one or more cell. The box member may comprise one or more internal webs to form the or each cell. The repair insert may be configured for insertion into the cell or one of the plurality of cells. One of the repair inserts may be provided in the or each cell of the box member.

At least in certain embodiments, the repair insert has an outer profile which at least substantially matches an interior profile of the box member or an interior profile of a cell of the box member.

The box member may have a uniform cross-section. At least in the region where the repair is to be affected, the box member may have a uniform cross-section. The box member may be an extruded member. Alternatively, the box member may comprise an assembly.

The at least one first reactor arm may connect the first tensioning arm to the first engaging member.

The repair insert may comprise a plurality of first reactor arms coupled to the first tensioning arm. The first reactor arms may extend substantially parallel to each other.

The at least one first reactor arm may be connected to the first tensioning arm. A first included angle may be formed between the at least one first reactor arm and the first tensioning arm. The first included angle may be an acute angle when the first clamping member is unloaded. In use, clamping the first clamping member to the box member may increase the first included angle. The increase in the first included angle may cause the at least one first reactor arm to bias the first engaging member outwardly.

The repair insert may comprise a hub. The first tensioning arm and the at least one first reactor arm may be connected to the hub. In use, the first tensioning arm may be operative to rotate the hub. The rotation of the hub may cause the at least one first reactor arm to apply the biasing force for biasing the first engaging member towards the first wall when the first clamping member is clamped to the wall of the box member. The first tensioning arm may be offset from a centre of the hub. The first tensioning arm may extend in a substantially tangential direction from the hub.

The first engaging member may comprise one or more grooves for receiving an adhesive to bond the repair insert to the box member.

The repair insert may comprise a second engaging member for engaging a second one of the walls of the box member; and at least one second reactor arm coupled to the first tensioning arm. The at least one second reactor arm may be operative to apply a biasing force for biasing the second engaging member towards the second wall when the first clamping member is clamped to wall of the box member.

The first and second walls may be disposed on opposite sides of the box member. The first reactor arm may be disposed on a first side of the first tensioning arm and the second reactor arm may be disposed on a first side of the first tensioning arm.

The at least one first reactor arm and the at least one second reactor arm may be disposed on opposite sides of the first tensioning arm. The at least one first reactor arm and the at least one second reactor arm may be at least substantially symmetrical about a centreline of the first tensioning arm.

The first and second engaging members may be configured to apply biasing forces in opposite directions to bias the first and second walls outwardly.

A second included angle may be formed between the at least one second reactor arm and the first tensioning arm. The second included angle may be an acute angle when the first clamping member is unloaded. The first and second reactor arms may be disposed in a V-shaped configuration when the first clamping member is unloaded. The angle between the first and second reactor arms may increase when the first clamping member is loaded. In other words, the V-shaped configuration of the first and second reactor arms may open when the first clamping member is loaded. A plurality of the first and second reactor arms may comprise a herringbone or chevron structure.

The first and second included angles may be at least substantially equal to each other. This may help to balance the first and second biasing forces applied to the first and second engaging members. In use, the first and second biasing forces may be at least substantially equal to each other.

In use, clamping the first clamping member to the box member increases the second included angle and causes the at least one second reactor arm to bias the second engaging member outwardly.

The second engaging member may comprise one or more grooves for receiving an adhesive to bond the repair insert to the box member.

The first clamping member may comprise a first threaded boss for receiving a mechanical fastener to clamp the first clamping member to the box member.

The first clamping member may comprise a first threaded bush for receiving a mechanical fastener to clamp the first clamping member to the box member. The first threaded bush may be formed separately from the first clamping member. The first threaded bush may be mounted to the first clamping member. The first threaded bush may, for example, comprise a captive or fixed nut which is mounted to the first clamping member. The first threaded bush may comprise a rivet nut which may be fixedly mounted to the first clamping member. The first threaded bush may comprise a blind rivet nut. The first threaded bush may be fixedly mounted to the first clamping member before the repair insert is inserted into the box member. In a variant, a separate first threaded bush or nut may be provided on an inside of the first clamping member. The first threaded bush or nut may be located against an interior of the first clamping member after the repair insert is inserted into the box member.

The first threaded bush may locate in a first channel formed on an inside of the first clamping member. The first tensioning arm may be connected to the first channel.

The repair insert may comprise a second clamping member for clamping against an interior of one of the walls of the box member; and a second tensioning arm connected to the second clamping member. The repair insert may comprise at least one third reactor arm coupled to the second tensioning arm. The at least one third reactor arm may be operative to apply a biasing force for biasing the first engaging member towards the first wall when the second clamping member is clamped to the wall of the box member.

The repair insert may comprise at least one fourth reactor arm coupled to the second tensioning arm. The at least one fourth reactor arm may be operative to apply a biasing force for biasing the second engaging member towards the second wall when the second clamping member is clamped to the wall of the box member.

The first tensioning arm and the second tensioning arm may be connected to opposing walls of the box member.

The first tensioning arm may be coupled to the second tensioning arm. A connector may be provided to couple the first and second tensioning arm. The connector may comprise a U-shaped or serpentine profile.

The box member may comprise a longitudinal box member or a longitudinal beam of a vehicle.

The second clamping member may comprise a second threaded boss for receiving a mechanical fastener to clamp the second clamping member to the box member.

The second clamping member may comprise a second threaded bush for receiving a mechanical fastener to clamp the second clamping member to the box member. The second threaded bush may be formed separately from the second clamping member. The second threaded bush may be mounted to the second clamping member. The second threaded bush may, for example, comprise a captive or fixed nut which is mounted to the second clamping member. The second threaded bush may comprise a rivet nut which may be fixedly mounted to the second clamping member. The second threaded bush may comprise a blind rivet nut. The second threaded bush may be fixedly mounted to the second clamping member before the repair insert is inserted into the box member. In a variant, a separate second threaded bush or nut may be provided on an inside of the second clamping member. The second threaded bush or nut may be located against an interior of the second clamping member after the repair insert is inserted into the box member.

The second threaded bush may locate in a second channel formed on an inside of the second clamping member. The second tensioning arm may be connected to the second channel.

The repair insert may be formed from a deformable material. The repair insert may, for example, be formed from a plastics material. The repair insert may be moulded, for example by an extrusion moulding process or an injection moulding process. Alternatively, the repair insert may be formed using an additive manufacturing process, such as a 3-dimensional (3D) printing process. The repair insert may be printed from a plastics material, for example. Other techniques may be used to form the repair insert.

According to a further aspect of the present invention there is provided a vehicle comprising a repair insert as described herein.

The repair insert may be disposed in a box member in the vehicle. The box member may be a longitudinal box member, for example forming a longitudinal beam. The longitudinal beam may be a front longitudinal beam for supporting a front body structure.

According to a further aspect of the present invention there is provided a method of repairing a box member having a plurality of walls; the method utilising a repair insert comprising at least one clamping member, at least one reactor arm and at least one engaging member; wherein the method comprises:
applying a structural adhesive to an outer surface of the at least one engaging member;
at least partially inserting the repair insert into the box member; and
clamping the at least one clamping member against an interior of one of the walls of the box member;
wherein clamping the clamping member displaces a tensioning arm connected to the clamping member causing the at least one reactor arm to apply a biasing force to bias the engaging member towards an associated wall of the box member.

The repair insert may comprise a hub. The hub may be connected to the at least one tensioning arm and the at least one reactor arm. The clamping of the at least one tensioning arm may cause the hub to rotate. The rotation of the hub may causes the at least one reactor arm to apply the biasing force to bias the at least one engaging member towards the associated wall of the box member.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a vehicle incorporating a repair insert in accordance with an embodiment of the present invention;

FIG. 2 shows an end view of the multi-cell box member in which the repair insert is installed;

FIG. 3 shows repair inserts installed in the box member shown in FIG. 2;

FIGS. 4A, 4B and 4C show perspective views of the repair inserts for installation in the cells of the box member shown in FIG. 3;

FIG. 5 shows an enlarged view of a first repair insert in accordance with an embodiment of the present invention;

FIGS. 6A to 6E illustrate the process of installing the repair inserts in a damaged box member and the mounting of a section of a replacement box member;

FIG. 7 shows a variant of the repair insert including a connector between the tension arms;

FIG. 8 shows a perspective view of the repair insert according to a further embodiment of the present invention;

FIG. 9 shows the repair inserts installed in a replacement box member;

FIG. 10 shows the repair inserts according to a further embodiment of the present invention installed in a replacement box member;

FIG. 11 shows the repair inserts prior to installation of threaded inserts for engaging mechanical fasteners to secure the repair inserts in position;

FIG. 12 shows the repair inserts after installation of the threaded inserts for engaging mechanical fasteners to secure the repair inserts in position;

FIG. 13 shows an end view of a first repair insert shown in FIG. 10;

FIG. 14 shows an end view of a second repair insert in FIG. 10; and

FIG. 15 shows an end view of a first repair insert shown in FIG. 10.

### DETAILED DESCRIPTION

A repair insert 1-n for repairing a box member 3 in accordance with an embodiment of the present invention is described herein with reference to the accompanying Figures. The repair insert 1-n is configured to form a structural brace for mounting a replacement box member 3A of the box member 3.

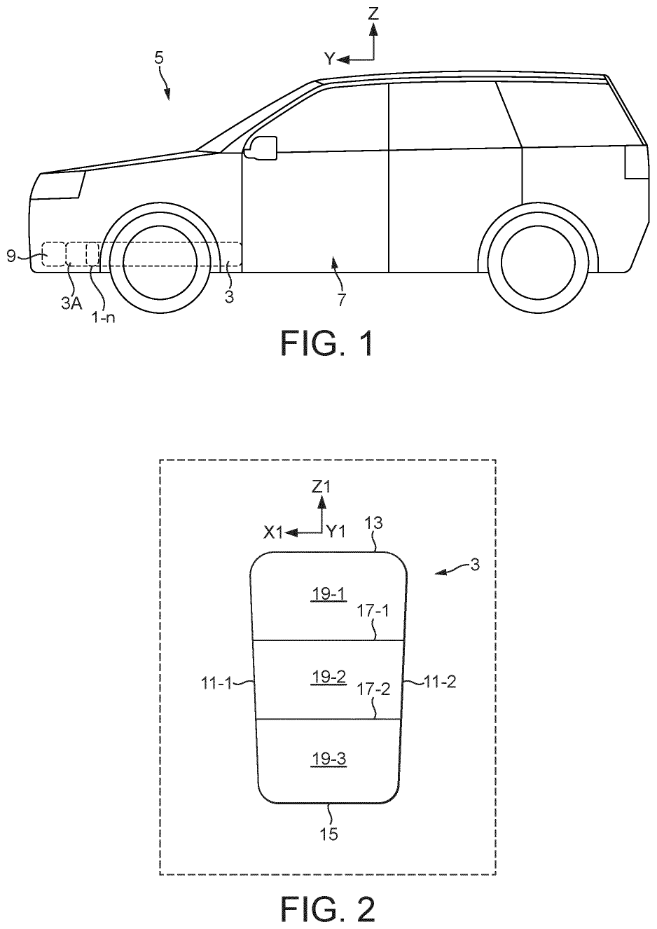

The box member 3 may be disposed in a vehicle 5. The vehicle 5 may, for example, be an automobile, a sports utility vehicle, a utility vehicle or other road vehicle. The repair insert 1-n is described herein with reference to the repair of the box member 3 disposed in an automobile, as shown in FIG. 1. The vehicle 5 is described herein with reference to a vehicle reference frame comprising a transverse axis X, a longitudinal axis Y and a vertical axis Z. As shown in FIG. 2, the box member 3 is described herein with reference to a local frame comprising a transverse axis X1, a longitudinal axis Y1 and a vertical axis Z1. The box member 3 forms part of a body structure 7 of the vehicle 5. The box member 3 in the present embodiment is a longitudinal support provided in the vehicle 5 to support a front body structure 9. The repair insert 1-n provides a structural repair.

The front body structure 9 may, for example, comprise one or more crush cans for absorbing collision energy; and/or a cross member for supporting a front bumper. It will be understood that the box member 3 may be used in other parts of the vehicle 5.

An end view of the box member 3 is shown in FIG. 2. The box member 3 has a closed section formed by a plurality of walls. The walls forming the box member 3 comprise a first sidewall 11-1, a second sidewall 11-2, an upper wall 13 and a lower wall 15. The box member 3 may also comprise one or more internal wall 17-n. The box member 3 in the present embodiment is trapezoidal in transverse section (i.e., in a plane perpendicular to the longitudinal axis Y1), but other shapes and profiles are envisaged. The first and second sidewalls 11-1, 11-2 are inclined at an acute angle relative to the vertical axis Z1. The upper and lower walls 13, 15 are substantially parallel to each other and the transverse axis X1. The box member 3 in the present embodiment is a regular trapezoid which is symmetrical about the vertical axis Z1. The box member 3 has a substantially constant section along the longitudinal axis Y1. The box member 3 in the present embodiment is an extruded member formed by an extrusion process. Other techniques, such as casting, forming or machining, may be used to form the box member 3. Alternatively, the box member 3 may be an assembly comprising a plurality of members. A plurality of sheet members may be assembled to form the box member 3.

The box member 3 may be a single-cell structure or a multi-cell structure. The box member 3 in the present embodiment is a multi-cell structure comprising a plurality of cells 19-n. The cells 19-n are formed internally and are open at each end of the box member 3. The box member 3 may comprise one or more of the internal walls 17-n to define the cells 19-n. The box member 3 may comprise two or more cells 19-n. The box member 3 in the present embodiment comprises three (3) cells 19-n. The cells 19-n comprise an upper cell 19-1, a middle cell 19-2 and a lower cell 19-3, as shown in FIG. 2. First and second internal walls 17-1, 17-2 in the box member 3 define the upper, middle and lower cells 19-1, 19-2, 19-3. The first and second internal walls 17-1, 17-2 extend between the first and second sidewalls 11-1, 11-2. In the present embodiment, the first and second internal walls 17-1, 17-2 are substantially parallel to the upper and lower walls 13, 15. The cells 19-n may have the same profile or may have different profiles. The upper, middle and lower cells 19-1, 19-2, 19-3 each comprise a trapezoid in transverse section. It will be understood that the box member 3 and/or the upper, middle and lower cells 19-1, 19-2, 19-3 may have different profiles.

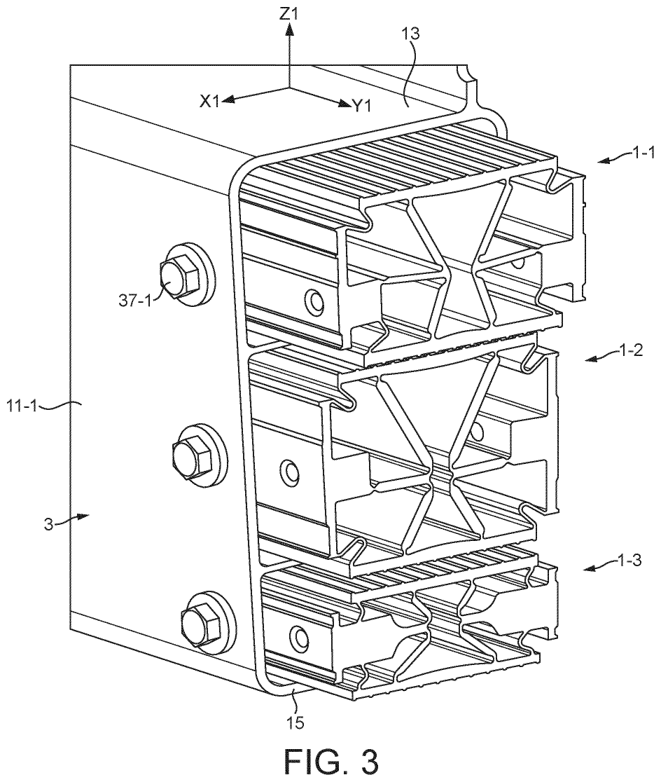

The repair insert 1-n is configured to be inserted into the cell 19-n formed in the box member 3. The repair insert 1-n is configured operatively at least substantially to match the internal profile of an associated cell 19-n. As shown in FIGS. 2 and 3, the upper, middle and lower cells 19-1, 19-2, 19-3 of the box member 3 have different profiles. In particular, the upper, middle and lower cells 19-1, 19-2, 19-3 have different heights and widths. As shown in FIG. 3, different variants of the repair insert 1-n are provided for installation in each of the upper, middle and lower cells 19-1, 19-2, 19-3.

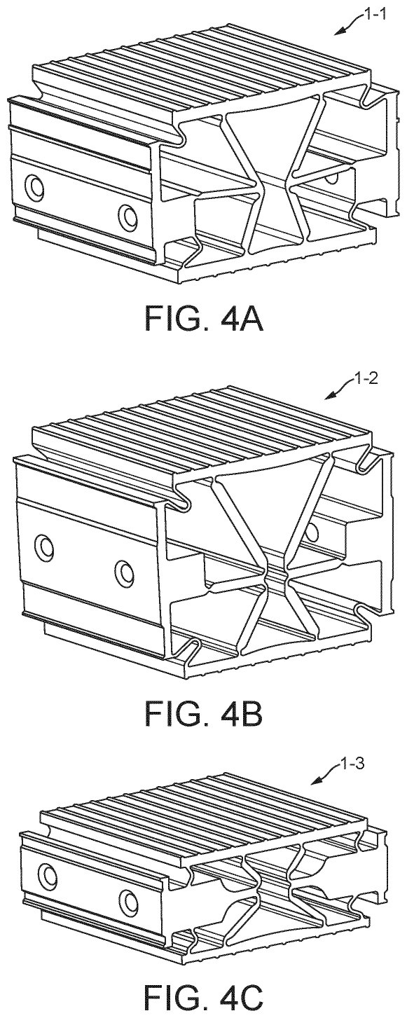

The external profile of each variant of the repair insert 1-n at least substantially matches the internal profile of a respective one of the upper, middle and lower cells 19-1, 19-2, 19-3. In the present embodiment, a first repair insert 1-1 is provided for installation in the upper cell 19-1; a second repair insert 1-2 is provided for installation in the middle cell 19-2; and a third repair insert 1-3 is provided for installation in the lower cell 19-3. The first repair insert 1-1 is shown in FIG. 4A; the second repair insert 1-2 is shown in FIG. 4B; and the third repair insert 1-3 is shown in FIG. 4C. Each of the first, second and third repair inserts 1-1, 1-2, 1-3 has an external profile which is trapezoidal in transverse section. It will be understood that the first, second and third repair inserts 1-1, 1-2, 1-3 may have different external profiles. The external profile of the first, second and third repair inserts 1-1, 1-2, 1-3 may adapt or change during installation to conform to the internal profile of the associated upper, middle and lower cells 19-1, 19-2, 19-3. By way of example, the repair insert 1-n could, for example, have a rectangular profile in transverse section. The rectangular profile of the insert 1-n may change to a trapezoidal profile during installation to conform to the internal shape of an associated cell 19-n.

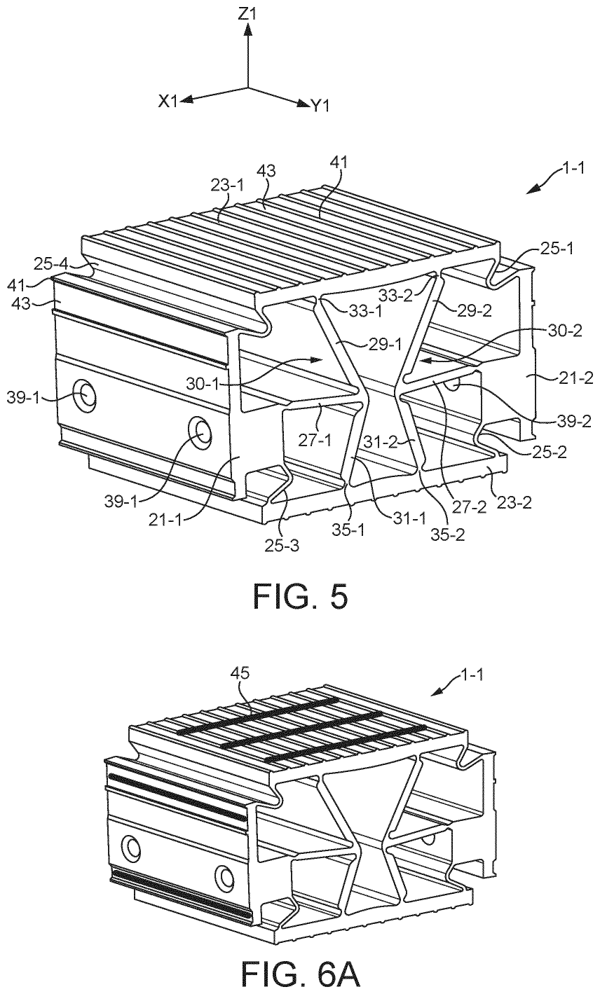

The first, second and third repair inserts 1-1, 1-2, 1-3 have substantially the same structure. For the sake of brevity, the structure of the first repair insert 1-1 will now be described in detail with reference to FIG. 5. The second and third repair inserts 1-2, 1-3 have corresponding structures.

The first repair insert 1-1 is configured to be inserted into the first cell 19-1. As described herein, the first repair insert 1-1 is configured to cooperate with the walls of the first cell 19-1. The first cell 19-1 is defined by the first sidewall 11-1, the second sidewall 11-2, the upper wall 13 and the first internal wall 17-1 of the first member 3. The first repair insert 1-1 is configured to cooperate with each of these walls. The box member 3 is trapezoidal in transverse section (i.e. in a plane perpendicular to the longitudinal axis Y1).

The first repair insert 1-1 comprises first and second clamping members 21-1, 21-2 for clamping against an interior of the first and second sidewalls 11-1, 11-2 respectively; and first and second engaging members 23-1, 23-2 for engaging the upper wall 13 and the first internal wall 17-1 of the box member 3. A stabiliser 25-n is provided at each corner of the first repair insert 1-1 to connect the first and second sidewalls 11-1, 11-2 to the first and second engaging members 23-1, 23-2. The stabiliser 25-n each comprise an inwardly directed U-shaped connector. The stabiliser 25-n forms a live hinge which accommodates relative movement of the first and second sidewalls 11-1, 11-2 and the first and second engaging members 23-1, 23-2. The first repair insert 1-1 is moulded from a plastic material, for example by an extrusion moulding process. The first repair insert 1-1 in the present embodiment has a unitary structure.

The first repair insert 1-1 comprises first and second tensioning arms 27-1, 27-2; and a plurality of reactor arms 29-n, 31-n for biasing the first and second engaging members 23-1, 23-2 towards the upper wall 13 and the first internal wall 17-1. The first tensioning arm 27-1 is connected to the first clamping member 21-1; and the second tensioning arm 27-2 is connected to the second clamping member 21-2. The first and second tensioning arms 27-1 may comprise a hinged connection to the first and second clamping members 21-1, for example by respective live hinges. The first and second tensioning arms 27-1, 27-2 extend in a transverse direction substantially parallel to the transverse axis X1. The reactor arms 29-n, 31-n extend between the first and second tensioning arms 27-1, 27-2 and the first and second engaging members 23-1, 23-2. The reactor arms 29-n, 31-n are each inclined at an oblique angle to the transverse axis X1. In the present embodiment, the reactor arms 29-n, 31-n are symmetrical about a vertical axis. The reactor arms 29-n, 31-n on a first side of the first repair insert 1-1 are arranged in a first V-shaped configuration (denoted generally by the reference numeral 30-1). The reactor arms 29-n, 31-n on a second side of the first repair insert 1-1 are arranged in a second V-shaped configuration (denoted generally by the reference numeral 30-2). The first and second V-shaped configurations 30-1, 30-2 open outwardly towards the first and second clamping members 21-1, 21-2 formed on the opposing sides of the first repair insert 1-1.

The reactor arms 29-n, 31-n comprise first and second upper reactor arms 29-1, 29-2; and first and second lower reactor arms 31-1, 31-2. The first and second upper reactor arms 29-1, 29-2 are connected to the first engaging member 23-1. First and second upper hinges 33-1, 33-2 are formed at the connection between the first and second upper reactor arms 29-1, 29-2 and the first engaging member 23-1. The first and second upper hinges 33-1, 33-2 are live hinges in the present embodiment. The first and second lower reactor arms 31-1, 31-2 are connected to the second engaging member 23-2. First and second lower hinges 35-1, 35-2 are formed at the connection between the first and second lower reactor arms 31-1, 31-2 and the second engaging member 23-2. The first and second lower hinges 35-1, 35-2 are live hinges in the present embodiment.

The first tensioning arm 27-1 is connected at a first end to the first clamping member 21-1; and at a second end to the first upper and lower reactor arms 29-1, 31-1. The second tensioning arm 27-2 is connected at a first end to the second clamping member 21-2; and at a second end to the second upper and lower reactor arms 29-2, 31-2. A first included angle α1 is formed between the first and second upper reactor arms 29-1, 29-2 and the first and second tensioning arms 27-1, 27-2 respectively. A second included angle α2 is formed between the first and second lower reactor arm 31-1, 31-1 and the first and second tensioning arms 27-1, 27-2 respectively. The first and second included angles α1, α2 may be the same as each other or different from each other. The first and second included angles α1, α2 are acute angles when the first and second tensioning arms 27-1, 27-2 are unloaded. As described herein, the magnitude of the first and second included angles α1, α2 increase as the first and second tensioning arms 27-1, 27-2 are loaded by clamping the first and second clamping members 21-1, 21-2. The first repair insert 1-1 comprises hinged connections between the first and second tensioning arms 27-1, 27-2 and the upper and lower reactor arms 29-1, 29-2, 31-1, 31-2. The hinged connections in the present embodiment are formed by live hinges.

The first and second clamping members 21-1, 21-2 are configured to receive first and second mechanical fasteners 37-1, 37-2 for mounting the first repair insert 1-1 to the box member 3 and to the replacement box member 3A. The mechanical fasteners 37-1, 37-2 each comprise a threaded bolt. The first and second clamping members 21-1, 21-2 comprise threaded bosses 39-1, 39-2 for receiving the mechanical fasteners 37-1, 37-2. The threaded bosses 39-1, 39-2 may be formed directly in the first and second clamping members 21-1, 21-2. Alternatively, a metal insert may optionally be provided in the first and second clamping members 21-1, 21-2 to form the threaded bosses 39-1, 39-2. The first and second mechanical fasteners 37-1, 37-2 are operative to clamp the first and second clamping members 21-1, 21-2 against the first and second sidewalls 11-1, 11-2 of the replacement box member 3. The clamping action of the first and second mechanical fasteners 37-1, 37-2 applies a force to the first and second tensioning arms 27-1, 27-2. The first and second tensioning arms 27-1, 27-2 are thereby displaced towards the first and second sidewalls 11-1, 11-2 respectively. This movement causes a rotation of the first and second upper reactor arms 29-1, 29-2 and the first and second lower reactor arms 31-1, 31-2 which results in the application of a biasing force to the first and second engaging members 23-1, 23-2. The first and second engaging members 23-1, 23-2 are biased outwardly by the first and second upper reactor arms 29-1, 29-2 and the first and second lower reactor arms 31-1, 31-2. At least in certain embodiments, the first repair insert 1-1 expands and the first and second engaging members 23-1, 23-2 are displaced away from each other.

The first repair insert 1-1 is configured to be bonded to the box member 3. The first and second clamping members 21-1, 21-2 and the first and second engaging members 23-1, 23-2 comprise a plurality of longitudinal ribs 41 arranged to form a plurality of channels 43 for receiving a structural adhesive (not shown). The longitudinal ribs 41 are formed on an exterior of the first and second clamping members 21-1, 21-2 and the first and second engaging members 23-1, 23-2.

The use of the first repair insert 1-1 to repair the replacement box member 3 will now be described. A portion of the replacement box member 3 may be damaged due to a frontal collision. In the event of a frontal collision, damage may be localised at the front of the replacement box member 3. The replacement box member 3 may comprise a section having localised damage. The method comprises removing the damaged section of the replacement box member 3. This typically comprises making a vertical cut through the replacement box member 3. One or more cut line may be defined on the replacement box member 3 to facilitate removal of the damaged section. The replacement box member 3A is prepared to butt up against the cut made in the replacement box member 3. The preparation of the replacement box member 3A may, for example, comprise making a complementary cut through a replacement section. Holes are formed in the first and second sidewalls 11-1, 11-2 of the replacement box member 3 to receive the first and second mechanical fasteners 37-1, 37-2 for mounting the first repair insert 1-1. A template or guide may be used to ensure the correct positioning of the holes in the replacement box member 3. The first and second mechanical fasteners 37-1, 37-2 are located such that the first repair insert 1-1 extends out of the replacement box member 3 for location inside the replacement box member 3A, as shown in FIG. 3. Corresponding holes are formed in the sidewalls of the replacement box member 3A to receive first and second mechanical fasteners 37-1, 37-2. A template or guide may be used to ensure the correct positioning of the holes in the replacement box member 3A. This process is repeated for the second and third repair inserts 1-2, 1-3.

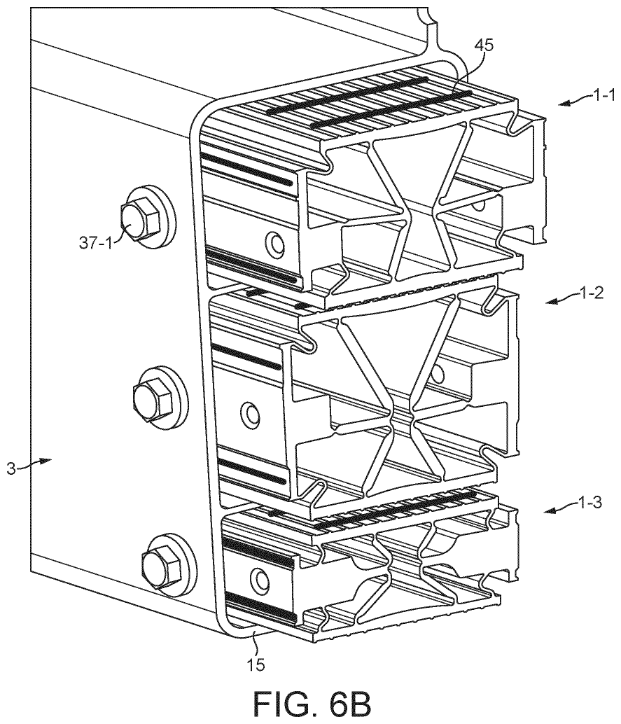

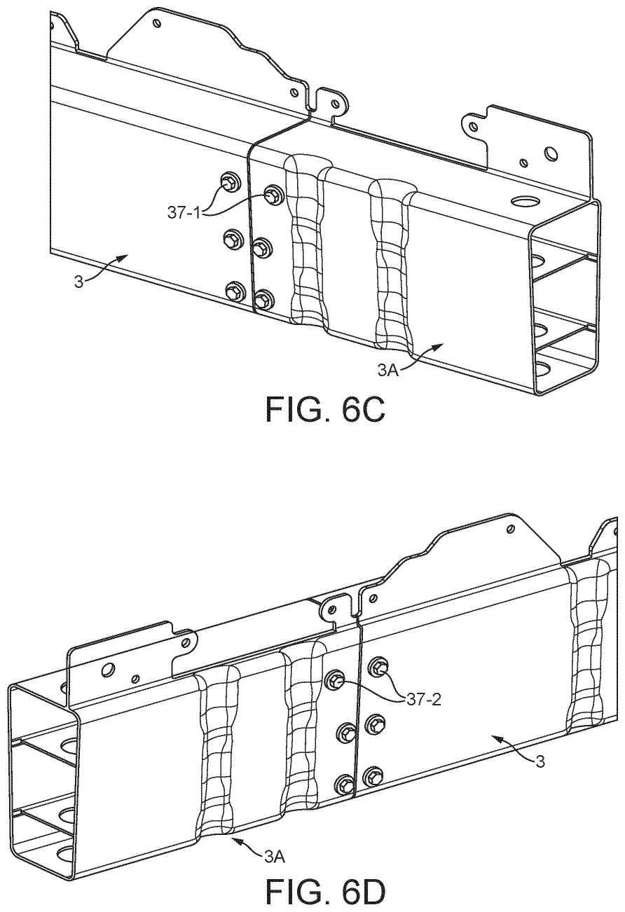

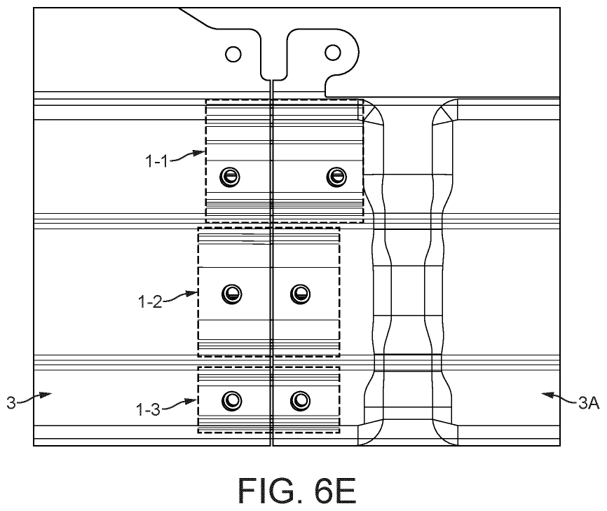

A structural adhesive is applied to the outer surfaces of the first, second and third repair inserts 1-1, 1-2, 1-3. As shown in FIG. 6A and 6B, the structural adhesive may be applied as one or more beads 45 extending transversely. The first, second and third repair inserts 1-1, 1-2, 1-3 are then located in the respective upper, middle and lower cells 19-1, 19-2, 19-3 of the box member 3, as shown in FIG. 6B. First and second mechanical fasteners 37-1, 37-2 are inserted to locate each of the first, second and third repair inserts 1-1, 1-2, 1-3 in the box member 3. The first and second mechanical fasteners 37-1, 37-2 prevent longitudinal movement of the first, second and third repair inserts 1-1, 1-2, 1-3. The replacement box member 3A is positioned on the projecting portions of each of the first, second and third repair inserts 1-1, 1-2, 1-3. As shown in FIGS. 6C and 6D, first and second mechanical fasteners 37-1, 37-2 are inserted to locate the replacement box member 3A to the first, second and third repair inserts 1-1, 1-2, 1-3. A side elevation of the box member 3 and the replacement box member 3A is shown in FIG. 6E. It will be understood that the first, second and third repair inserts 1-1, 1-2, 1-3 could be installed in the replacement box member 3A to form a repair assembly which is then mounted to the box member 3.

The first and second mechanical fasteners 37-1, 37-2 are then tightened to clamp the first and second clamping members 21-1, 21-2 against the first and second sidewalls 11-1, 11-2 of the replacement box member 3. The first and second clamping members 21-1, 21-2 are displaced towards the respective first and second sidewalls 11-1, 11-2. The first and second tensioning arms 27-1, 27-2 are thereby displaced causing the first and second upper reactor arms 29-1, 29-2 and the first and second lower reactor arms 31-1, 31-2 to rotate. The rotation of the first and second upper reactor arms 29-1, 29-2 and the first and second lower reactor arms 31-1, 31-2 applies a biasing force to the first and second engaging members 23-1, 23-2. The first and second engaging members 23-1, 23-2 are thereby displaced outwardly towards the upper wall 13 and the first internal wall 17-1. The first and second mechanical fasteners 37-1, 37-2 are fastened to the box member 3 and the replacement box member 3A to secure both sides of the repaired joint. A uniform contact is established between the first repair insert 1-1 and each of the box member 3 and the replacement box member 3A. The structural adhesive is allowed to cure to form an adhesive bond between the respective surfaces. The first and second mechanical fasteners 37-1, 37-2 remain in position such that the resulting repair provides both mechanical and adhesive fastening. The process is performed in respect of each of the first, second and third repair inserts 1-1, 1-2, 1-3.

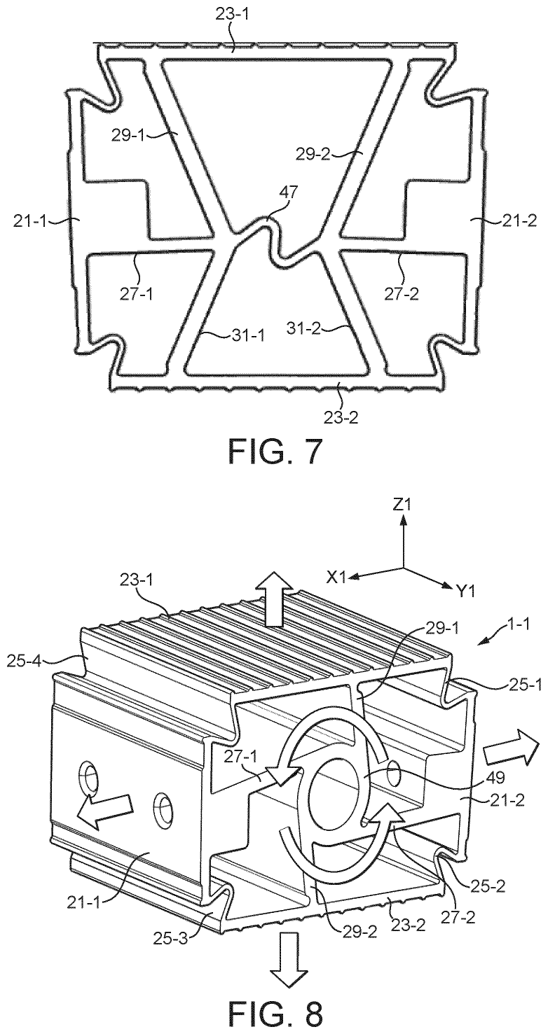

A variant of the first repair insert 1-1 is shown in FIG. 7. In this embodiment, a coupling 47 is provided to connect the first and second tensioning arms 27-1, 27-2 to each other. The coupling 47 comprises a web or sheet member extending between the first and second tensioning arms 27-1, 27-2. The coupling 47 comprises a serpentine profile to enable the first and second tensioning arms 27-1, 27-2 to be displaced apart from each other. In a variant, the coupling 47 may be deformable to enable the first and second tensioning arms 27-1, 27-2 to be displaced apart from each other.

The first repair insert 1-1 relies on the displacement of the first and second tensioning arms 27-1, 27-2 to displace the first and second upper reactor arms 29-1, 29-2 and the first and second lower reactor arms 31-1, 31-2. A further embodiment of the first repair insert 1-1 is shown in FIG. 8. Like reference numerals are used for like features in the description of this embodiment of the first repair insert 1-1.

The first repair insert 1-1 comprises first and second clamping members 21-1, 21-2 for clamping against an interior of the first and second sidewalls 11-1, 11-2 respectively; and first and second engaging members 23-1, 23-2 for engaging the upper wall 13 and the first internal wall 17-1 of the box member 3. A stabiliser 25-n is provided at each corner of the first repair insert 1-1 to connect the first and second sidewalls 11-1, 11-2 to the first and second engaging members 23-1, 23-2. The first repair insert 1-1 is moulded from a plastic material, for example by an extrusion moulding process.

The first repair insert 1-1 comprises first and second tensioning arms 27-1, 27-2; and first and second reactor arms 29-1, 29-1. In the present embodiment, the first repair insert 1-1 comprises a hub 49. The hub 49 is circular in the present embodiment but other shapes are also envisaged. The first and second tensioning arms 27-1, 27-2 and the first and second reactor arms 29-1, 29-2 are each connected to the hub 49. The first and second tensioning arms 27-1, 27-2 and the first and second reactor arms 29-1, 29-2 are angularly separated from each other around the hub 49 and extend tangentially outwardly from the hub 49. The hub 49 is configured to rotate when the first and second clamping member 21-1, 21-2 are clamped to the respective first and second sidewalls 11-1, 11-2 of the box member 3. In particular, the first and second clamping member 21-1, 21-2 apply a load to the first and second tensioning arms 27-1, 27-2 which causes the hub 49 to rotate. The rotation of the hub 49 displaces the first and second reactor arms 29-1, 29-1 outwardly which applies a biasing force to the first and second engaging members 23-1, 23-2. At least in certain embodiments, the rotation of the hub 49 causes the first repair insert 1-1 to expand by displacing the first and second engaging members 23-1, 23-2 away from each other.

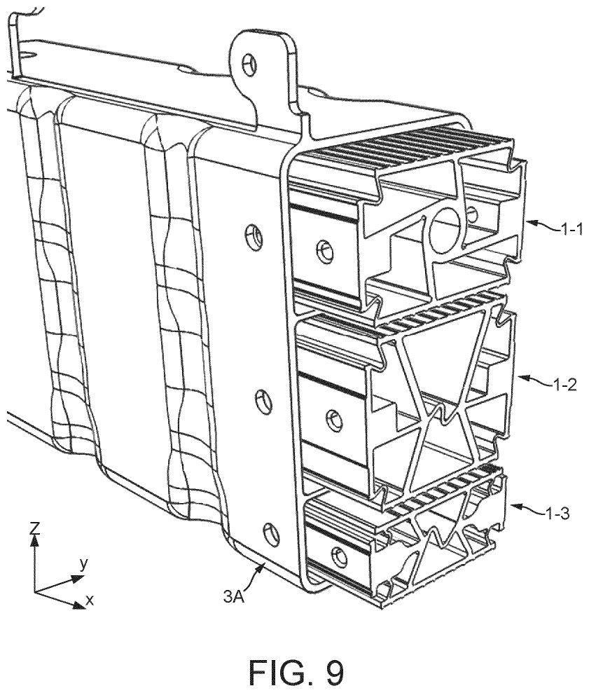

The first and second clamping members 21-1, 21-2 are configured to receive first and second mechanical fasteners 37-1, 37-2 for mounting the first repair insert 1-1 to the box member 3 and to the replacement box member 3A. As in the previous embodiment, the mechanical fasteners 37-1, 37-2 each comprise a threaded bolt. The first and second clamping members 21-1, 21-2 comprise threaded bosses 39-1, 39-2 for receiving the mechanical fasteners 37-1, 37-2. The threaded bosses 39-1, 39-2 may be formed directly in the first and second clamping members 21-1, 21-2. A metal insert may optionally be provided in the first and second clamping members 21-1, 21-2 to form the threaded bosses 39-1, 39-2. The first and second mechanical fasteners 37-1, 37-2 are operative to clamp the first and second clamping members 21-1, 21-2 against the first and second sidewalls 11-1, 11-2 of the replacement box member 3. The first repair insert 1-1 is shown located in the replacement box member 3A in FIG. 9. It will be understood that the different embodiments of the repair inserts 1-n may be used in combination with each other, as shown in FIG. 9.

The first repair insert 1-1 according to the present embodiment substantially unchanged from the previous embodiment. The first repair insert 1-1 is located in the first cell 19-1 formed in the box member 3 and the replacement box member 3A. The mechanical fasteners 37-1, 37-2 are secured to clamp the first and second clamping members 21-1, 21-2 to the first and second sidewalls 11-1, 11-2 of the replacement box member 3. The first and second engaging members 23-1, 23-2 are thereby displaced outwardly to contact the upper wall 13 and the first internal wall 17-1 of the first cell 19-1. This may provide more uniform contact between the first repair insert 1-1 and each of the box member 3 and the replacement box member 3A. This may promote adhesion and, at least in certain embodiments, may improve the structural integrity of the repair.

It will be understood that the second repair insert 1-2 and the third repair insert 1-3 may have similar configurations.

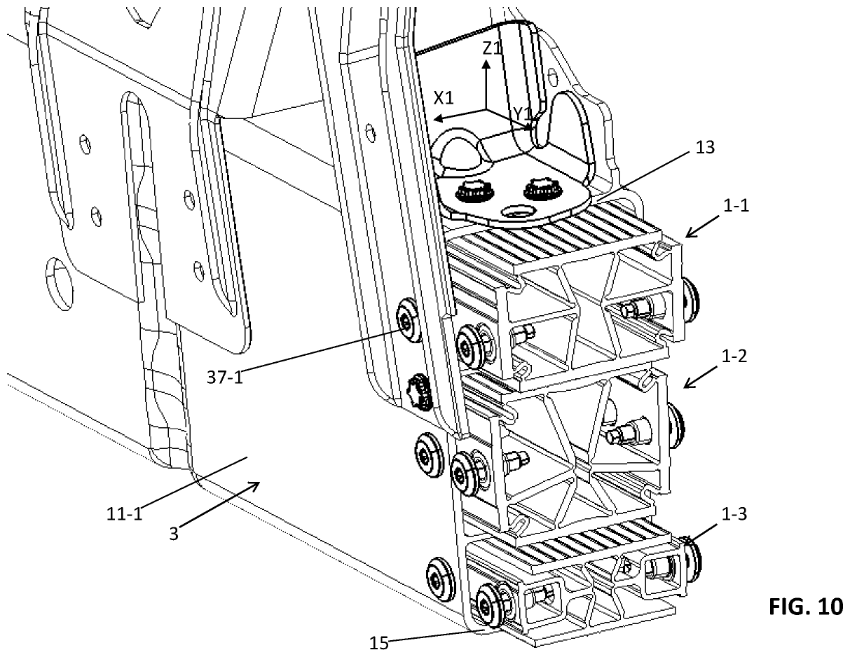

A further embodiment of the repair insert 1-n will now be described with referenced to FIGS. 10 to 15. For the sake of brevity, the description herein focuses on the differences between the present embodiment and the above embodiment. Like reference numerals are used for like features.

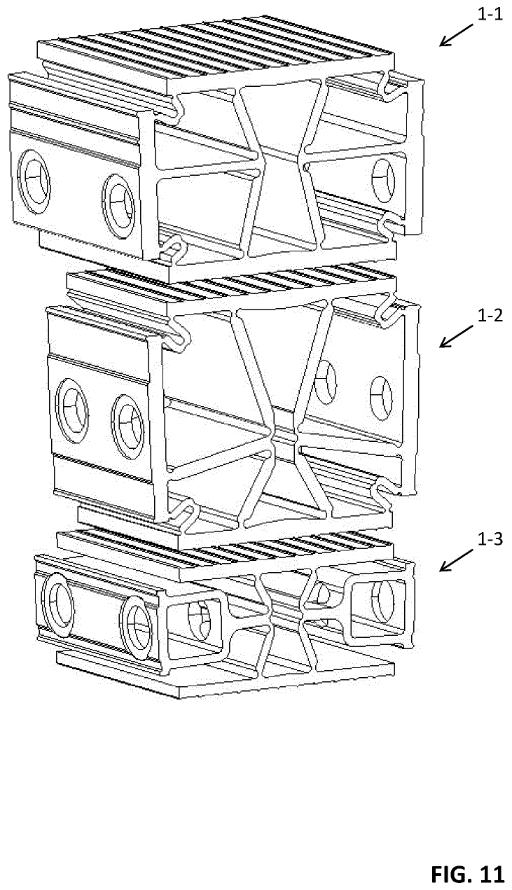

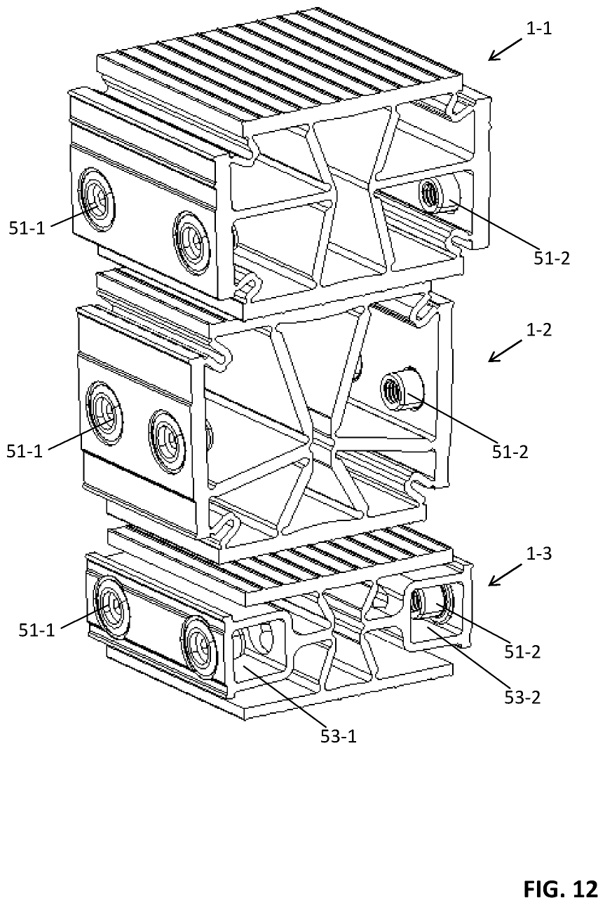

As shown in FIG. 10, different variants of the repair insert 1-n are provided for installation in each of the upper, middle and lower cells 19-1, 19-2, 19-3. The external profile of each variant of the repair insert 1-n at least substantially matches the internal profile of a respective one of the upper, middle and lower cells 19-1, 19-2, 19-3. A first repair insert 1-1 is provided for installation in the upper cell 19-1; a second repair insert 1-2 is provided for installation in the middle cell 19-2; and a third repair insert 1-3 is provided for installation in the lower cell 19-3. The external profile of the first, second and third repair inserts 1-1, 1-2, 1-3 may adapt or change during installation to conform to the internal profile of the associated upper, middle and lower cells 19-1, 19-2, 19-3. As described herein, the first, second and third repair inserts 1-1, 1-2, 1-3 each have first and second inserts 51-n for cooperating with the first and second mechanical fasteners 37-1, 37-2. The first, second and third repair inserts 1-1, 1-2, 1-3 are shown in FIG. 11 prior to installation of the first and second inserts 51-n; and in FIG. 12 after installation of the first and second inserts 51-n. The first, second and third repair inserts 1-1, 1-2, 1-3 may be moulded from a plastics material, for example by an extrusion process. Alternatively, the first, second and third repair inserts 1-1, 1-2, 1-3 may be formed using a 3-dimensional (3D) printing process. The first, second and third repair inserts 1-1, 1-2, 1-3 may be printed from a plastics material, for example. The first and second threaded bosses may be formed integrally with the first and second clamping members 21-1, 21-2 using a 3D printing process. Other techniques may be used to form the first, second and third repair inserts 1-1, 1-2, 1-3.

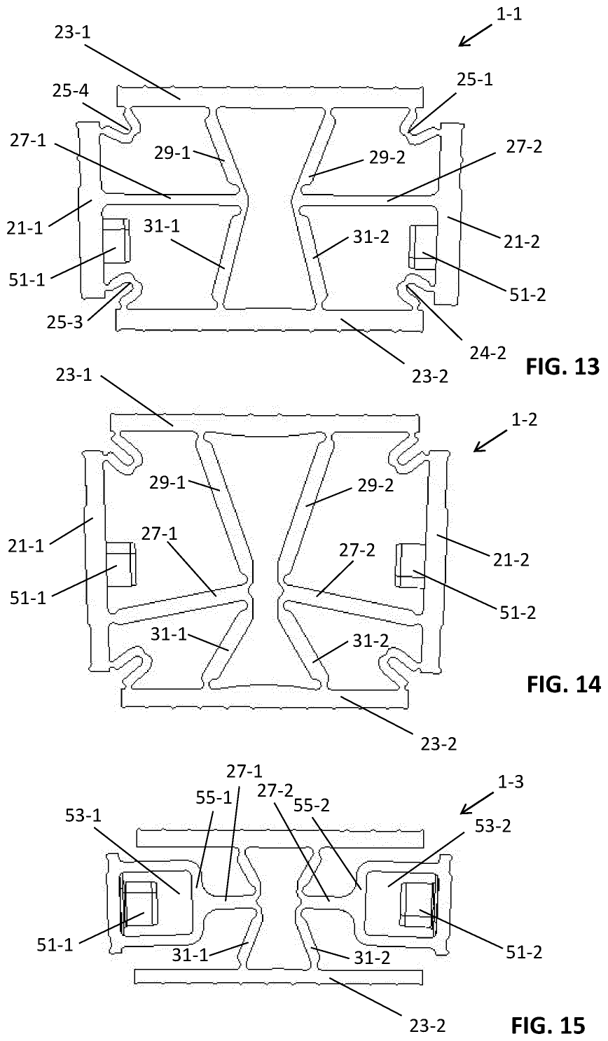

The first and second repair inserts 1-1, 1-2 have substantially the same structure. For the sake of brevity, the structure of the first repair insert 1-1 will now be described in detail with reference to FIG. 13. The first repair insert 1-1 comprises first and second clamping members 21-1, 21-2 for clamping against an interior of the first and second sidewalls 11-1, 11-2 respectively; and first and second engaging members 23-1, 23-2 for engaging the upper wall 13 and the first internal wall 17-1 of the box member 3. A stabiliser 25-n is provided at each corner of the first repair insert 1-1 to connect the first and second sidewalls 11-1, 11-2 to the first and second engaging members 23-1, 23-2. The stabiliser 25-n each comprise an inwardly directed U-shaped connector. The stabiliser 25-n forms a live hinge which accommodates relative movement of the first and second sidewalls 11-1, 11-2 and the first and second engaging members 23-1, 23-2. The first repair insert 1-1 is moulded from a plastic material, for example by an extrusion moulding process. The first repair insert 1-1 in the present embodiment has a unitary structure.

The first repair insert 1-1 comprises first and second tensioning arms 27-1, 27-2; and first and second upper and lower reactor arms 29-n, 31-n for biasing the first and second engaging members 23-1, 23-2 towards the upper wall 13 and the first internal wall 17-1. The first tensioning arm 27-1 is connected to the first clamping member 21-1; and the second tensioning arm 27-2 is connected to the second clamping member 21-2. The first and second tensioning arms 27-1 may comprise a hinged connection to the first and second clamping members 21-1, for example by respective live hinges. The first and second tensioning arms 27-1, 27-2 extend in a transverse direction substantially parallel to the transverse axis X1. The upper and lower reactor arms 29-n, 31-n extend between the first and second tensioning arms 27-1, 27-2 and the first and second engaging members 23-1, 23-2.

The first and second clamping members 21-1, 21-2 are configured to receive first and second mechanical fasteners 37-1, 37-2 for mounting the first repair insert 1-1 to the box member 3 and to the replacement box member 3A. The mechanical fasteners 37-1, 37-2 each comprise a threaded bolt. In the present embodiment, first and second clamping members 21-1, 21-2 comprise inserts 51-n having a threaded aperture for receiving the mechanical fasteners 37-1, 37-2. The inserts 51-n may, for example, be metal inserts. As shown in FIGS. 12 and 13, the inserts 51-n in the present embodiment comprise first and second rivet nuts 51-1, 51-2 which are fixedly mounted to the first and second clamping members 21-1, 21-2 respectively. The first and second rivet nuts 51-1, 51-2 are blind rivet nuts which are inserted through an aperture formed in the first and second clamping members 21-1, 21-2. The first and second rivet nuts 51-1, 51-2 are then deformed to engage the first and second clamping members 21-1, 21-2. The first and second rivet nuts 51-1, 51-2 are thereby fixedly mounted to the first and second clamping members 21-1, 21-2 respectively. The first and second clamping members 21-1, 21-2 are pre-installed in the first repair insert 1-1. In use, the first repair insert 1-1 is inserted with the first and second rivet nuts 51-1, 51-2 installed. The first and second rivet nuts 51-1, 51-2 do not protrude above an outer surface of the first and second clamping members 21-1, 21-2 to facilitate insertion of the first repair insert 1-1 in the upper cell 19-1. It will be understood that other types of insert 51-n may be used to engage the first and second mechanical fasteners 37-1, 37-2. In the present embodiment, the first and second rivet nuts 51-1, 51-2 are offset from the first and second tensioning arms 27-1, 27-2. In particular, the first and second rivet nuts 51-1, 51-2 are offset vertically from the first and second tensioning arms 27-1, 27-2. In a variant, the first and second tensioning arms 27-1, 27-2 may comprise a cut-out or an aperture to receive the first and second rivet nuts 51-1, 51-2.

The second repair insert 1-2 is shown in FIG. 14 and has substantially the same configuration as the first repair insert 1-1. The third repair insert 1-3 is shown in FIG. 15. Unlike the first and second repair inserts 1-1, 1-2, the third repair insert 1-3 does not include stabilisers 25-n for connecting the first and second sidewalls 11-1, 11-2 to the first and second engaging members 23-1, 23-2. Thus, there is no direct connection between the first and second sidewalls 11-1, 11-2 and the first and second engaging members 23-1, 23-2. As shown in FIG. 13, the third repair insert 1-3 comprises first and second tensioning arms 27-1, 27-2; and first and second upper and lower reactor arms 29-n, 31-n for biasing the first and second engaging members 23-1, 23-2 towards the upper wall 13 and the first internal wall 17-1.

The first and second clamping members 21-1, 21-2 comprise respective first and second channels 53-1, 53-2 configured to receive the first and second mechanical fasteners 37-1, 37-2. First and second inserts 51-1, 51-2 in the form of first and second rivet nuts 51-1, 51-2 are mounted inside the first and second channels 53-1, 53-2. The first and second tensioning arms 27-1, 27-2 are connected to an inner wall 55-1, 55-2 of the first and second channels 53-1, 53-2 respectively.

The installation and operation of the first, second and third repair inserts 1-1, 1-2, 1-3 according to the present embodiment is substantially unchanged from the previous embodiment.

It will be appreciated that various changes and modifications can be made to the present invention without departing from the scope of the present application.

1. A repair insert for repairing a box member having a plurality of walls; the repair insert comprising:
a first clamping member for clamping against an interior of one of the walls of the box member;
a first engaging member for engaging a first one of the walls of the box member;
a first tensioning arm connected to the first clamping member; and
at least one first reactor arm coupled to the first tensioning arm;
wherein the at least one first reactor arm is operative to apply a biasing force for biasing the first engaging member towards the first wall when the first clamping member is clamped to the wall of the box member.

2. A repair insert as claimed in claim 1, wherein the at least one first reactor arm is connected to the first tensioning arm; a first included angle being formed between the at least one first reactor arm and the first tensioning arm, the first included angle being an acute angle when the first clamping member is unloaded.

3. A repair insert as claimed in claim 2, wherein, in use, clamping the first clamping member to the box member increases the first included angle and causes the at least one first reactor arm to bias the first engaging member outwardly.

4. A repair insert as claimed in claim 1 comprising a hub, the first tensioning arm and the at least one first reactor arm being connected to the hub;
wherein the first tensioning arm is operative to rotate the hub to cause the at least one first reactor arm to apply the biasing force for biasing the first engaging member towards the first wall when the first clamping member is clamped to the box member.

5. A repair insert as claimed in claim 1, wherein the first engaging member comprises one or more grooves for receiving an adhesive to bond the repair insert to the box member.

6. A repair insert as claimed in claim 1 comprising:
a second engaging member for engaging a second one of the walls of the box member;
at least one second reactor arm coupled to the first tensioning arm;
wherein the at least one second reactor arm is operative to apply a biasing force for biasing the second engaging member towards the second wall when the first clamping member is clamped to the wall of the box member.

7. A repair insert as claimed in claim 6, wherein the first and second engaging members are configured to apply biasing forces in opposite directions to bias the first and second walls outwardly.

8. A repair insert as claimed in claim 6, wherein a second included angle is formed between the at least one second reactor arm and the first tensioning arm, the second included angle being an acute angle when the first clamping member is unloaded.

9. A repair insert as claimed in claim 8, wherein, in use, clamping the first clamping member to the box member increases the second included angle and causes the at least one second reactor arm to bias the second engaging member outwardly.

10. A repair insert as claimed in claim 6, wherein the second engaging member comprises one or more grooves for receiving an adhesive to bond the repair insert to the box member.

11. A repair insert as claimed in claim 1, wherein the first clamping member comprises a first threaded bush for receiving a mechanical fastener to clamp the first clamping member to the box member.

12. A repair insert as claimed in claim 1, comprising:
a second clamping member for clamping against an interior of one of the walls of the box member;
box member a second tensioning arm connected to the second clamping member; and
at least one third reactor arm coupled to the second tensioning arm;
wherein the at least one third reactor arm is operative to apply a biasing force for biasing the first engaging member towards the first wall when the second clamping member is clamped to the wall of the box member.

13. A repair insert as claimed in claim 12 comprising:
a second engaging member for engaging a second one of the walls of the box member;
at least one second reactor arm coupled to the first tensioning arm, wherein the at least one second reactor arm is operative to apply a biasing force for biasing the second engaging member towards the second wall when the first clamping member is clamped to the wall of the box member; and
at least one fourth reactor arm coupled to the second tensioning arm,
wherein the at least one fourth reactor arm is operative to apply a biasing force for biasing the second engaging member towards the second wall when the second clamping member is clamped to the wall of the box member.

14. A repair insert as claimed in claim 12, wherein the first tensioning arm and the second tensioning arm are connected to opposing walls of the box member.

15. A repair insert as claimed in claim 12, wherein the first tensioning arm is coupled to the second tensioning arm.

16. A repair insert as claimed in claim 12, wherein the second clamping member comprises a second threaded bush for receiving a mechanical fastener to clamp the second clamping member to the box member.

17. A vehicle comprising the repair insert according to claim 1.

18. A vehicle as claimed in claim 17, wherein the repair insert is disposed in a longitudinal box member.

19. A method of repairing a box member having a plurality of walls; the method utilising a repair insert comprising at least one clamping member, at least one reactor arm and at least one engaging member; wherein the method comprises:
applying a structural adhesive to an outer surface of the at least one engaging member;
at least partially inserting the repair insert into the box member; and
clamping the at least one clamping member against an interior of one of the walls of the box member;
wherein clamping the at least one clamping member displaces a tensioning arm connected to the clamping member causing the at least one reactor arm to apply a biasing force to bias the engaging member towards an associated wall of the box member.

20. A method as claimed in claim 19, wherein the repair insert comprising a hub connected to the at least one tensioning arm and the at least one reactor arm;
wherein clamping the at least one tensioning arm rotates the hub and causes the at least one reactor arm to apply the biasing force to bias the at least one engaging member towards the associated wall of the box member.
